(19) United States
(12) Patent Application Publication
(10) Pub. No.: US 2013/0165096 A1
(43) Pub. Date: Jun. 27, 2013

(54) INCOMING CALL FORWARDING METHOD AND COMMUNICATION DEVICE HAVING INCOMING CALL FORWARDING FUNCTION

(71) Applicant: QIANG YOU, Shenzhen City (CN)

(72) Inventor: QIANG YOU, Shenzhen City (CN)

(21) Appl. No.: 13/654,453

(22) Filed: Oct. 18, 2012

(30) Foreign Application Priority Data
Dec. 27, 2011 (CN) 201110443309.4

(51) Int. Cl. H04W 4/16

(52) U.S. Cl. 455/417

(57) ABSTRACT

A method is used to forward an incoming call received by a communication device during a charging process of a power supply unit of the communication device. The communication device includes a power input interface, and a power supply unit electrically connected to the power input interface. A control signal is generated when the incoming call is received by the communication device and the power supply unit is in the charging state. The incoming call is forwarded to a predetermined communication device when the control signal is generated.

### BACKGROUND

1. Technical Field

Embodiments of the present disclosure relate to incoming call management, and particularly to a method for forwarding incoming calls received by a communication device during the charging of a battery of the communication device.

2. Description of Related Art

When an incoming call is received by a communication device during the charging of a battery of the communication device, a user may directly answer the incoming call without disconnecting the communication device from the battery charger. However, a great amount of Electromagnetic (EM) radiation may be emitted out during the battery charging of the communication device, which may be very harmful to the user. Therefore, there is room for improvement in the art.

### BRIEF DESCRIPTION OF THE DRAWINGS

FIG. 1 illustrates a schematic block diagram of one embodiment of a communication device.

FIG. 2 illustrates a circuit diagram of one embodiment of a detection unit of the communication device of FIG. 1.

FIG. 3 illustrates a circuit diagram of another embodiment of the detection unit.

FIG. 4 shows a flowchart of one embodiment of an incoming call forwarding method of the communication device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”.

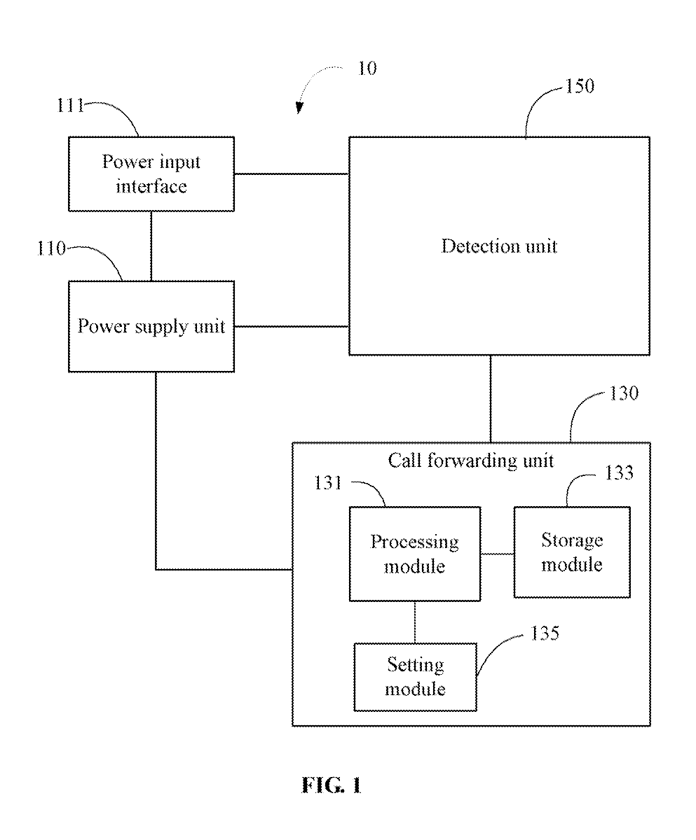

FIG. 1 is a schematic block diagram of one embodiment of a communication device 10. The communication device 10 includes a power supply unit 110, a power input interface 111, a call forwarding unit 130, and a detection unit 150. The power input interface 111, call forwarding unit 130, and detection unit 150 respectively connect to the power supply unit 110. The power supply unit 110 provides voltage signals for each of the power input interface 111, call forwarding unit 130, and detection unit 150. In the embodiment, the communication device 10 may be, for example, a mobile phone, a personal digital assistant, a fixed telephone, or other similar devices. FIG. 1 shows one example of the communication device 10, in other embodiments, the communication device 10 can include more or fewer components such as storage devices and processors, or have a different configuration of the components.

The power supply unit 110 may be a battery, such as a lithium battery. The power supply unit 110 is charged when an external power source, such as a power source of 12V, is connected to the power input interface 111. The power input interface 111 may be a universal serial bus (USB) interface, or other similar interface that capable of power signal transmission.

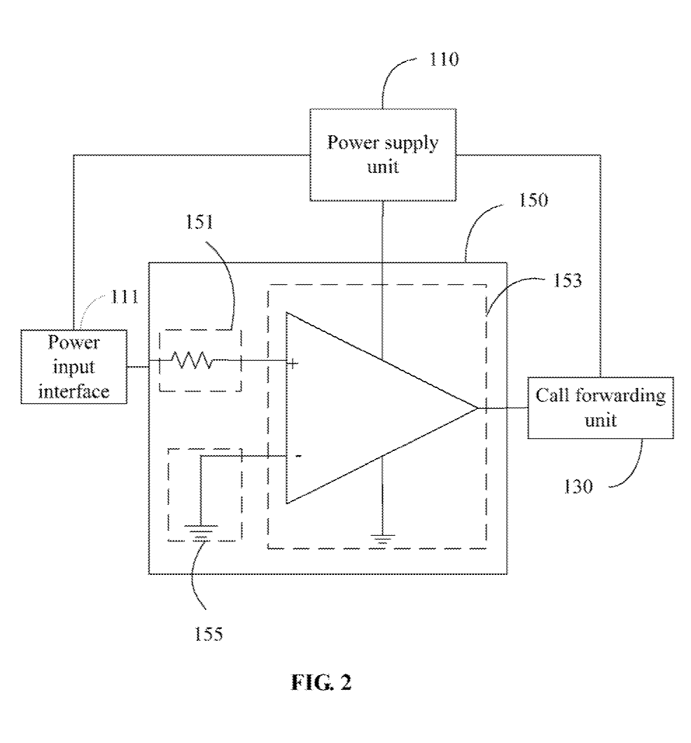

The detection unit 150 detects whether the power supply unit 110 is in a charging state when an incoming call is received by the communication device 10. The charging state indicates that the power supply unit 10 is being charged at the time when the incoming call is received. In one embodiment, as shown in FIG. 2, the detection unit 150 is powered by the power supply unit 110. The detection unit 150 includes a voltage detection circuit 151, a comparison circuit 153, and a reference voltage generation circuit 155. The voltage detection circuit 151 is electrically connected to the power input interface 111 to detect a voltage inputted from the power input interface 111. The reference voltage generation circuit 155 provides a predetermined low level voltage, such as a voltage of 0V or 0.3V. The comparison circuit 153 is electrically connected to the voltage detection circuit 151 and the reference voltage generation circuit 155, and determines whether the power supply unit 110 is in the charging state by comparing the detected voltage inputted from the power input interface 111 with the predetermined low level voltage. For example, if the detected voltage is greater than the predetermined low level voltage, the power supply unit 110 is in the charging state. Otherwise, if the detected voltage is equal to or less than the predetermined low level voltage, the power supply unit 110 is not in the charging state. Additionally, if the power supply unit 110 is in the charging state, the comparison circuit 153 generates a control signal, such as a high level signal of 5V, and outputs the control signal to the call forwarding unit 130.

In the embodiment, the voltage detection circuit 151 comprises at least one resistance to detect the voltage inputted from the power input interface 111. The comparison circuit 153 includes a comparator which includes two input ports and an output port. The voltage detection circuit 151 is connected to a positive input port of the comparator, the reference voltage generation circuit 155 is connected to a negative input port of the comparator, and the output port is configured to output the control signal to the call forwarding unit 130.

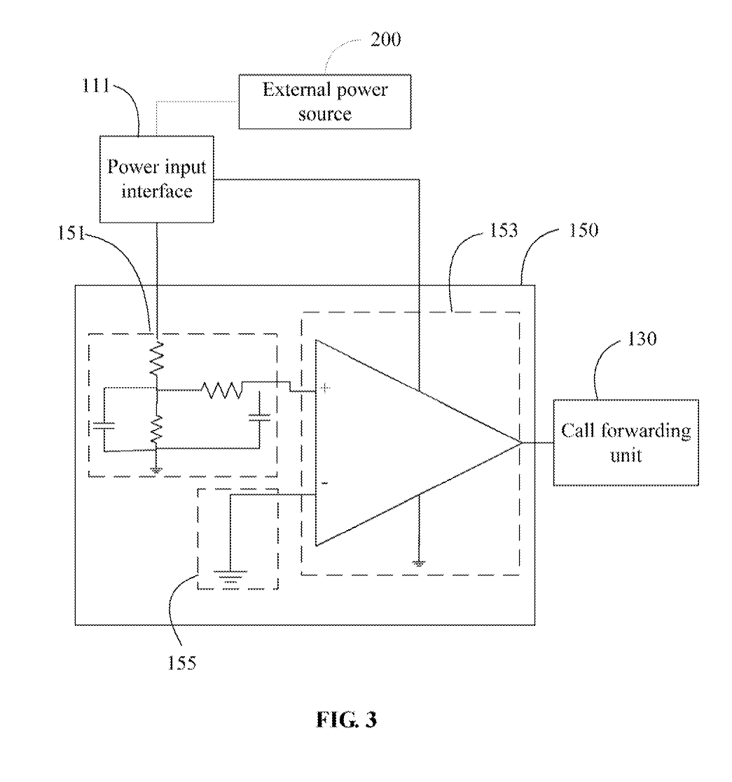

In another embodiment, as shown in FIG. 3, the detection unit 150 may be powered by an external power source 200 connected to the power input interface 111 during a charging process of the power supply unit 110. The detection unit 150 is activated only when the external power source 200 is connected to the power input interface 111. Additionally, the detection unit 150 further includes a resistor-capacitor (RC) circuit configured to filter power signals output from the external power source.

The call forwarding unit 130 forwards the incoming call to a predetermined communication device when the control signal is generated. In one embodiment, the call forwarding unit 130 may execute a call forwarding program of the communication device 10 to forward the incoming call. In particular, the call forwarding unit 130 includes a processing module 131, a storage module 133, and a setting module 135 (see FIG. 1). The setting module 135 sets identification (ID) such as a phone number of the predetermined communication device. The storage module 133 stores the ID of the communication device and the call forwarding program. The processing module 131 executes the call forwarding program to forward the incoming call to the predetermined communication device having the ID stored in the storage module 133, when the control signal is received by the call forwarding unit 130.

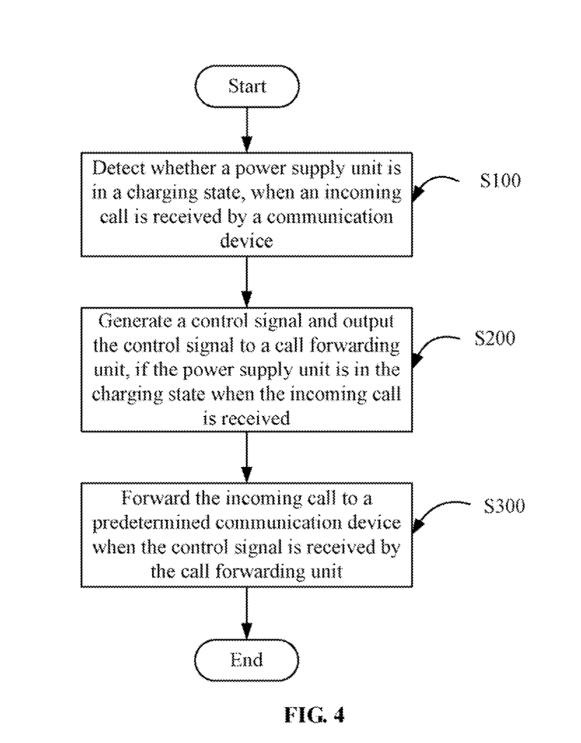

Referring to FIG. 4, a flowchart of one embodiment of an incoming call forwarding method of the communication device 10 of FIG. 1 is shown. Depending on the embodiment, additional steps may be added, others removed, and the ordering of the steps may be changed.

In step S100, when an incoming call is received by the communication device 10, the detection unit 150 detects whether the power supply unit 110 is in a charging state.

In step S200, when the power supply unit 110 is in the charging state and the incoming call is received, the detection unit 150 generates a control signal and outputs the control signal to the call forwarding unit 130,.

In step S300, the call forwarding unit 130 forwards the incoming call to a predetermined communication device when the control signal is received from the detection unit 150.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A communication device, the communication device comprising:
a power input interface;
a power supply unit electrically connected to the power input interface;
a detection unit that detects whether the power supply unit is in a charging state when an incoming call is received by the communication device, and generates a control signal when the power supply unit is in the charging state; and
a call forwarding unit that receives the control signal from the detection unit, and forwards the incoming call to a predetermined communication device when the control signal is received.

2. The communication device according to claim 1, wherein the detection unit comprises:
a voltage detection circuit electrically connected to the power input interface to detect a voltage inputted from the power input interface;
a reference voltage generation circuit providing a predetermined low level voltage; and
a comparison circuit electrically connected to the voltage detection circuit and the reference voltage generation circuit, wherein the comparison circuit determines whether the power supply unit is in the charging state by comparing the detected voltage inputted from the power input interface with the predetermined low level voltage, and generates a control signal if the power supply unit is determined to be in the charging state.

3. The communication device according to claim 2, wherein the power supply unit is determined to be in the charging state when the detected voltage is greater than the predetermined low level voltage, and the power supply unit is determined to not be in the charging state when the detected voltage is equal to or less than the predetermined low level voltage.

4. The communication device according to claim 1, wherein the detection unit is electrically connected to the power input interface and the power supply unit, and the detection unit is powered by the power supply unit.

5. The communication device according to claim 1, wherein the detection unit is electrically connected to the power input interface, and the detection unit is powered by an external power source connected to the power input interface during a charging process of the power supply unit.

6. The communication device according to claim 5, wherein the detection unit comprises a resistor-capacitor (RC) circuit configured to filter power signals output from the external power source.

7. The communication device according to claim 1, wherein the call forwarding unit comprises:
a setting module that sets identification (ID) of the predetermined communication device;
a storage module that stores the ID of the predetermined communication device; and
a processing module that executes a call forwarding program to forward the incoming call to the predetermined communication device having the ID stored in the storage module, when the control signal is received by the call forwarding unit.

8. The communication device according to claim 1, wherein the power supply unit is a battery that is capable of being charged by an external power source.

9. A computerized incoming call forwarding method of a communication device, the communication device comprising a power input interface, a power supply unit electrically connected to the power input interface, and a detection unit electrically connected to the power input interface, the method comprising:
detecting whether the power supply unit is in a charging state when an incoming call is received by the communication device using the detection unit;
generating a control signal using the detection unit when the power supply unit is in the charging state; and
forwarding the incoming call to a predetermined communication device when the control signal is generated.

10. The method according to claim 9, wherein the detecting step comprises:
detecting a voltage inputted from the power input interface;
comparing the detected voltage inputted from the power input interface with a predetermined low level voltage; and
determining that the power supply unit is in the charging state if the detected voltage is greater than the predetermined low level voltage, or determining that the power supply unit is not in the charging state if the detected voltage is equal to or less than the predetermined low level voltage.

11. The method according to claim 9, wherein the detection unit is electrically connected to the power supply unit and the detection unit is powered by the power supply unit.

12. The method according to claim 9, wherein the detection unit is powered by an external power source connected to the power input interface during a charging process of the power supply unit.

13. The method according to claim 12, wherein the detection unit comprises a resistor-capacitor (RC) circuit configured to filter power signals output from the external power source.

14. The method according to claim 9, further comprising:
setting identification (ID) of the predetermined communication device, and storing the ID of the predetermined communication device.

15. The method according to claim 14, wherein the forwarding step further comprises:
executing a call forwarding program to forward the incoming call to the predetermined communication device having the ID, when the control signal is generated.

16. The method according to claim 9, wherein the power supply unit is a battery that is capable of being charged by an external power source.
